(19) United States
(12) Patent Application Publication
(10) Pub. No.: US 2004/0138963 A1
(43) Pub. Date: Jul. 15, 2004

(54) Product presentation equipment

(76) Inventors: Frank Kirschner, Wedemark (DE); Rolf Meyer, Wennigsen (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/693,177

(22) Filed: Oct. 23, 2003

(30) Foreign Application Priority Data
Oct. 25, 2002 (DE) 102 50 004.5

(51) Int. Cl. G06F 17/60

(52) U.S. Cl. 705/27

(57) ABSTRACT

The invention relates to product presentation equipment. The object of the present invention is to replace, as far as possible, the sales conversation between the customer and the seller, whereby at the same time all possible information on the corresponding product is made available to the customer in an attractive manner, without in this case him having to read long-winded operating instructions, but the customer can substantially carry out the check on the product quality and product features. Product presentation equipment, consisting of a screen, a computer system connected to the screen in which information on various products can be stored and reproduced on the screen by operating appropriate operating devices, a device for mounting at least two different products, for which visualizable information is stored in the computer, a switching device assigned to each product, the switching device being automatically activated when a product is taken into use and/or out of the mounting, so that with the activation of the switching device information (model designation, technical data, price) from the computer on the product is automatically produced on the screen.

### CROSS-REFERENCE TO RELATED APPLICATION

This application claims priority of German Application No.102 50 004.5, filed Oct. 25, 2002, the complete disclosure of which is hereby incorporated by reference.

### BACKGROUND OF THE INVENTION

a) Field of the Invention

The invention relates to product presentation equipment.

b) Description of the Related Art

For many years there has been a trend, when selling products, that the sales consultation is in fact highly valued by the customers, but often can hardly be offered by the sales personnel, whether it be because the products being sold are relatively complicated and the sales personnel do not have adequate product knowledge or because the sales personnel are so overstretched by a large number of customers that they can only engage a few customers in a consultation.

Finally, this situation fundamentally results in dissatisfied customers and dissatisfied customers mean fewer sales successes than desired.

### OBJECT AND SUMMARY OF THE INVENTION

The primary object of the present invention is to replace the sales conversation between the customer and the seller to a great extent, at the same time making available to the customer all possible information on the corresponding product in an attractive manner, in this case without the customer having to read long-winded operating instructions, but the customer can substantially carry out a check on the product quality and the product features.

In accordance with the invention, product presentation equipment comprises a screen, a computer system connected to the screen in which information on various products can be stored and reproduced on the screen by operating appropriate operating devices, a device for accommodating at least two different products for which visualizable information is stored in the computer and a switching device assigned to each product. The switching device is automatically activated when a product is taken into use and/or out of the housing, so that with the activation of the switching device, information (model designation, technical data, price) from the computer on the product is automatically reproduced on the screen. The product represents an electroacoustic device and the equipment comprises means for the proper testing and/or for the activation of the electroacoustic device.

The product presentation system according to the invention or the equipment is distinguished by the fact that it comprises mountings for several products virtually in the manner of a counter, e.g. the product palette of the manufacturer of electroacoustic appliances, e.g. headphones, microphones and the like.

The equipment according to the invention also comprises a screen, preferably a touchscreen, which is connected to a computer on which the product-specific information and the desired customer information is stored, which can be automatically invoked via the operation of appropriate operating devices or by the user.

In this case the products are housed in mountings, with a sensor, by means of which it is registered whether the product is in the mounting or not, being assigned to each individual mounting.

If, e.g., a customer wants to obtain information on the various headphones of a headphones manufacturer, the various headphones of the manufacturer are stored in the product mountings. In particular, the visualizable information on the headphones can be represented via the screen, on the screen it also being possible to provide the information which is suitable and helpful for the operation of the product presentation equipment by the customer.

Furthermore, in the above-mentioned example it is also provided that at least one sound data signal source is provided, by means of which the sound data on the headphones can be reproduced in audible manner for the customer, with the customer being able to select an item of music of a music style desired by him via the operation.

The headphones in each case lie on mountings, which each have a switch which may have a mechanical or non-mechanical design, e.g. also an electrical or optical design. As long as headphones (wireless or wire-bound) lie in the mounting, the switch is in the “off” position; as soon as the headphones are removed from the mounting it is in the “on” position.

With the “on” position at least to some extent the data on the screen which is assigned to the respective product is automatically provided via a control mechanism connected to the switch. This information may, for example, consist of the model type designation and generally information on the respective product, such as also on the product price and the like, the system having a so-called content management, which enables the operator of the product presentation equipment to input, for example, the respective shop price or other individual information in the desired manner.

The user may also be guided, by appropriate use of the operating devices, such as on an Internet page, through several information pages and the user also has the opportunity of setting the various sound data signal parameters, such as loudness, balance, sound, etc., at a desired value by the appropriate operation of operating devices.

If the respective headphones are placed back in their mounting, all set sound signal parameters are brought into their initial position, and under certain circumstances it may also be sensible to connect them to a time circuit which brings about the initial position of the sound signal parameters, if after a predetermined period, e.g. 30 or 60 seconds, no other headphones were taken from the mountings, so that in such cases when the customer takes second headphones after first headphones, he can still hear via the second headphones with the previously adjusted sound signal data parameters.

In the initial state of the product presentation equipment according to the invention, the customer is asked via the screen to put on a product, e.g. headphones. Of course, by selecting appropriate information fields, the customer may also select information on a specific headphones product directly by operating the touchscreen.

If the customer has put on the headphones (mounting switch in the “on” position, further to this, for example, he has the opportunity of operating three different buttons on the screen. Here general product information is assigned to the first button, special features of the headphones are assigned to the second button and the precise technical data on the headphones are assigned to the third button, and by pressing the respective button the corresponding information content is reproduced on the screen.

At the same time, the user of the system can also obtain information on an alternative operation of the operating devices, e.g. on the Internet page of the product supplier generally on the supplier itself and also other products.

### BRIEF DESCRIPTION OF THE DRAWINGS

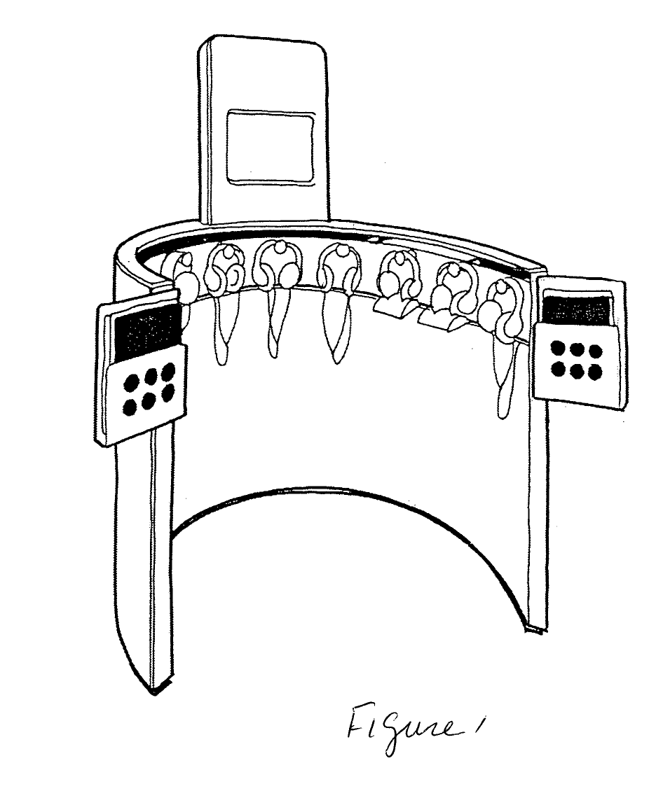

A perspective view of a product presentation system according to the invention is represented in FIG. 1.

### DESCRIPTION OF THE PREFERRED EMBODIMENTS

Referring to FIG. 1, there it can be seen how mountings for a plurality of headphone sets are constructed on an almost semicircular frame. The headphones are either cable-bound or wireless and connected to the base station which in turn is again fixed to the frame so that when the respective headphones are placed in the mounting, they also come to lie in the base station and then the batteries of the headphones can be corresponding charged.

Furthermore, a corresponding wireless signal connection (e.g. HF or infrared), by means of which the sound signal data can be transmitted to the headphones, exists between wireless headphones and the corresponding base station.

In accordance with a further exemplified embodiment, the product presentation equipment consists of a screen, a computer system connected to the screen, in which information on various products can be stored and reproduced on the screen by operating appropriate operating devices, a device for accommodating at least two different products for which visualizable information is stored in the computer, a switching device assigned to each product, wherein the switching device is automatically activated when a product is taken into use and/or out of the mounting, so that with the activation of the switching device information (model designation, technical data, price) from the computer on the product is reproduced on the screen.

While the foregoing description and drawings represent the present invention, it will be obvious to those skilled in the art that various changes may be made therein without departing from the true spirit and scope of the present invention.

What is claimed is:

1. Product presentation equipment, comprising:
a screen;
a computer system connected to the screen in which information on various products can be stored and reproduced on the screen by operating appropriate operating devices;
device for accommodating at least two different products, for which visualizable information is stored in the computer;
a switching device assigned to each product;
wherein the switching device is automatically activated when a product is taken into use and/or out of the housing, so that with the activation of the switching device, information (model designation, technical data, price) from the computer on the product is automatically reproduced on the screen; and
wherein the product represents an electroacoustic device and the equipment comprises means for the proper testing and/or for the activation of the electroacoustic device.

2. Equipment according to claim 1, wherein further information on the product taken into use can be invoked by the operation of the operating devices.

3. Equipment according to claim 1, wherein the product is headphones and wherein the equipment comprises means to transmit audio signals to the headphones.

4. Equipment according to claim 3, wherein the equipment comprises more than one sound data source and the respectively desired sound data source for reproduction via headphones can be selected via the setting of the operating devices.

5. Equipment according to claim 1, wherein the screen is a touchscreen.

6. Equipment according to claim 1, wherein a connection to the Internet page of the product supplier can be produced by operating the operating devices.

7. Equipment according to claim 1, wherein the switching device is an infrared switching device by means of which the removal of a product from the mounting can be recorded.

8. Equipment according to claim 1, wherein the switching device is a mechanical switch which is moved into the “off” position when the product lies in the mounting and is moved into the “on” position when the product is removed from the mounting.
